(19) United States
(12) Patent Application Publication
(10) Pub. No.: US 2025/0228232 A1
(43) Pub. Date: Jul. 17, 2025

(54) Method for Operating an Agricultural Spraying Device Having a Direct Infeed System

(71) Applicant: Amazonen-Werke H. Dreyer SE & Co. KG, Hasbergen (DE)

(72) Inventors: Frank GROßE PRUES, Bersenbrück (DE); Timo KLEMANN, Belm (DE); Christoph KÜHN, Bad Iburg (DE)

(73) Assignee: Amazonen-Werke H. Dreyer SE & Co. KG, Hasbergen (DE)

(21) Appl. No.: 18/690,624

(22) PCT Filed: Aug. 29, 2022
(86) PCT No.: PCT/EP2022/073892

§ 371 Date: Mar. 8, 2024

(30) Foreign Application Priority Data
Sep. 10, 2021 (DE) 10 2021 123 498.0

(51) Int. Cl. A01M 7/00

(52) U.S. Cl. CPC A01M 7/0092

(57) ABSTRACT

A method for operating an agricultural spraying device having a direct infeed system, comprising the following steps: feeding an active substance into a line system of the agricultural spraying device, said line system being connected to application elements and conducting a carrier fluid, by means of the direct infeed system in order to generate a spray fluid containing the active substance and the carrier fluid, wherein the feeding in of the active substance takes place at an infeed point of the line system; and changing the active substance concentration of the spray fluid by adjusting the active substance infeed and/or by adjusting the volume flow of the carrier fluid at the infeed point.

### CROSS REFERENCE TO RELATED APPLICATIONS

The present application claims priority under 35 U.S.C. § 365 to PCT/EP2022/073892 filed on Aug. 29, 2022 and under 35 U.S.C. § 119 (a) to German Application No. 10 2021 123 498.0 filed on Sep. 10, 2021.

### BACKGROUND

The disclosure relates to a method for operating an agricultural spraying device having a direct infeed system and a system for controlling the application of spray fluid by an agricultural spraying device.

Agricultural spraying devices with a direct infeed can add active substances, such as pesticides or fertilizers, to a carrier fluid as required during the application process. Generic spraying devices usually have a main tank for the carrier fluid. The carrier fluid is fed to the spray nozzles of the spraying device via a line system. In addition, generic spraying devices usually have an active substance container for the active substance to be metered in. This fluid is usually dosed too high for direct application in the field. The active substance is fed into a line system via a feed pump, in which the carrier fluid is also fed, and mixed with the carrier fluid. The infeed of the active substance can be carried out on a partial area-specific basis, for example using an application map.

There are usually several meters of hose line between the infeed point of the direct infeed and the spray nozzles. If a new concentration of active substance is to be composed, the entire fluid between the infeed point and the spray nozzles must be replaced. Due to the length of the line between the infeed point and the spray nozzles on the boom, there is a time delay between changing the active substance infeed rate and the actual discharge of the intended spray fluid with the changed active substance concentration from the spray nozzles.

Therefore, these spraying devices can experience a time lag between the infeed change and the discharge of adjusted spray fluid from the application elements.

### SUMMARY

The problem can be solved by a method wherein a control unit automatically causes the active substance concentration of the spray fluid to be changed before the application elements reach an area-internal application limit running within the agricultural area, so that the spray fluid with the changed active substance concentration is present at one or more application elements when the area-internal application limit is reached.

Due to the fact that the spray fluid with the changed active substance concentration is present at the one or more application elements when the area-internal application limit is reached, the spray fluid with the changed active substance concentration can also be applied directly at the area-internal application limit. Preferably, a feed pump of the direct infeed system doses the new active substance quantity into the carrier fluid in advance, so that a spray fluid with the intended active substance concentration is discharged from the one or more application elements as soon as the one or more application elements pass the area-internal application limit.

The control unit can, for example, take the area-internal application limits from an application map and compare them with a determined current position of the application elements. Among other things, application maps can include information about areas with different target application rates of an active substance on an agricultural area. The area-internal application limits and/or target application rates of active substance can also be generated directly during a pass with an additional sensor on the machine, in particular from parameters of the agricultural area and/or plants standing on it that can be determined by sensors. Furthermore, the area-internal application limits and/or the target application rates of active substance can be determined in advance using satellite data, drone overflights or yield data. For example, application maps can specify that 500 ml of growth regulator per hectare should be dosed in a dry area of the field with weak plants and 800 ml per hectare in a moist area with strong plants.

By feeding in the active substance, a spray fluid comprising a specific area-related application rate of active substance and a specific area-related application rate of carrier fluid is generated. When changing the active substance concentration, the ratio of the area-related application rate of active substance and the area-related application rate of carrier fluid is preferably changed. The carrier fluid can be, for example, water, liquid fertilizer or a ready-mixed plant protection broth comprising, for example, water and active substance. The application elements can be spray nozzles, for example.

In a preferred embodiment, the control unit causes the active substance concentration of the spray fluid to be changed at an adjustment location on the agricultural area and/or at an adjustment time during an application process. The control unit determines the adjustment location and/or the adjustment time, taking into account a dynamic delay in the provision of the spray fluid with the changed active substance concentration at the one or more application elements. The provision delay depends on the flow rate of the spray fluid through the line system and/or on the properties of the line system. The provision delay depends on or corresponds to the flow time of the spray fluid with the changed active substance concentration from the infeed point to the one or more application elements. The line system properties on which the provision delay depends are, for example, the line volume, the line lengths and/or the line cross-sections.

The current position of the spraying device and/or the application elements can be determined using a satellite navigation system, in particular a GPS system. From the navigation data, the driving speed of the agricultural spraying device can also be determined. Alternatively or additionally, the driving speed of the agricultural spraying device can be determined by sensors.

In a preferred embodiment, the provision delay determined by the control unit relates to the delay time between the adjustment time and the time at which the one or more application elements reach the area-internal application limit. Alternatively, the provision delay determined by the control unit relates to the lag distance between the adjustment location and the area-internal application limit. The provision delay also depends on the driving speed until the area-internal application limit is reached. The driving speed can be constant until the area-internal application limit is reached. Furthermore, the driving speed can also be changed by accelerating or decelerating until the area-internal application limit is reached. A planned change in the driving speed until the area-internal application limit is reached is taken into account by the control unit when determining the provision delay.

Furthermore, in another embodiment the control unit calculates the lag distance taking into account a fluid exchange volume, an area-related application rate of carrier fluid or spray fluid and/or the working width of the spraying device until the area-internal application limit is reached. The fluid exchange volume preferably relates to the line volume between the infeed point and the application elements. If individual application elements are deactivated, the fluid exchange volume does not include the line volume of the branch lines leading to the deactivated application elements, as there is no exchange of fluid in these branch lines. The spray fluid in the line volume at the adjustment time or at the adjustment location must be exchanged for the spray fluid with the changed active substance concentration so that the spray fluid with the changed active substance concentration is present at the one or more application elements. For example, an area-related application rate of 200 liters per hectare corresponds to an area-related application rate of 0.02 liters per m². With a fluid exchange volume of 40 liters, an area of 2000 m² can be treated with the fluid exchange volume. With a working width of 36 m, the lag distance is therefore approx. 55.6 m. The adjustment location is therefore approx. 55.6 m before the area-internal application limit.

The method can be further developed in that the control unit can calculate the lag distance, taking into account the travel path and application interruptions occurring along the travel path, until the area-internal application limit is reached. In particular for upcoming cornering or turning operations, for example in the headland area, the travel path must be known so that the route can be taken into account until the area-internal application limit is reached. As the travel paths on the agricultural area do not usually change when different work steps are carried out, the travel path can be recorded during a previous work step or stored by a planning system so that the recorded or stored travel path can be used to calculate the lag distance. Application interruptions can occur particularly in the headland area. As application interruptions delay the exchange of the fluid within the line volume, these can be taken into account when calculating the lag distance.

In another preferred embodiment, the flow rate, in particular the flow volume flow rate and/or the flow velocity, of the carrier fluid and/or the spray fluid through the line system is measured by means of one or more flow measuring devices. The control unit preferably calculates the provision delay as a function of the measured flow rate. By measuring the flow rate, the time until a certain amount of fluid has been exchanged can be calculated for a known line volume. The flow rate can be measured, for example, by a central sensor in a main flow line. Alternatively, the flow rate can be measured using several sensors in different lines. The provision delay is preferably linearly dependent on the flow rate, in particular on the volume flow rate and/or on the flow velocity of the spray fluid. Since the proportion of active substance in the spray fluid is low, the flow rate of the carrier fluid can also be used as the basis for determining the provision delay. The flow rate can be measured upstream or downstream of the infeed point. If necessary, the volume of the infeed can be added or subtracted in order to determine the flow value at a different position.

In a further preferred embodiment, imminent, in particular planned, changes in the flow rate, in particular the volume flow rate and/or the flow velocity, of the carrier fluid and/or the spray fluid through the line system are determined until the area-internal application limit is reached, in particular evaluation of a planned application routine. The flow rate of the carrier fluid and/or the spray fluid through the line system can change, for example, if an application map provides for the application of an increased amount of carrier fluid and/or spray fluid in a specific area of the agricultural area. Furthermore, the flow rate of the carrier fluid and/or the spray fluid through the line system can change by activating or deactivating individual application elements. The control unit preferably calculates the provision delay as a function of the determined imminent changes in the flow rate of the carrier fluid and/or the spray fluid through the line system until the area-internal application limit is reached. In this way, the provision delay also takes into account anticipated local changes in the application rate of carrier fluid and/or spray fluid. Furthermore, a planned activation and deactivation of application elements is taken into account when calculating the provision delay.

In another preferred embodiment, the current driving speed is recorded. Furthermore, imminent, in particular planned, changes in the driving speed until the area-internal application limit is reached can be determined within the scope of the method, in particular by evaluating a planned application routine. The application routine can, for example, provide for the driving speed to be reduced before a turning process and increased again after the turning process has been carried out. Furthermore, a planned application routine can provide for a speed reduction in the curve area or an increase in speed when transitioning to a straight section of the route. The control unit preferably calculates the provision delay as a function of the determined current driving speed and/or the determined imminent changes in driving speed until the area-internal application limit is reached. The driving speed and the flow rate preferably develop linearly in relation to each other. If the driving speed increases, the provision delay decreases, as the application rate increases with the driving speed for a fixed application rate per area. If the flow rate or the line volume or fluid exchange volume are taken into account, the driving speed does not necessarily have to be taken into account when determining the provision delay.

The method also can be developed in that the current target application quantity of carrier fluid and/or spray fluid is determined. Alternatively or additionally, imminent, in particular planned, changes to the target application quantity of carrier fluid and/or spray fluid are determined until the area-internal application limit is reached, in particular by evaluating a planned application routine. The control unit preferably calculates the provision delay as a function of the determined current target application quantity of carrier fluid and/or spray fluid and/or the determined imminent changes in the target application quantity of carrier fluid and/or spray fluid. The current target application rate of carrier fluid and/or spray fluid and the upcoming changes until the area-internal application limit is reached can be stored in the control unit as application parameters or called up by the control unit. If the target application rate increases, the provision delay is reduced as the exchange of fluid within the line volume is carried out more quickly.

In a further embodiment, the number of active application elements and/or the position of the active application elements in the line system is determined. Active application elements are the application elements via which spray fluid is applied to the agricultural area. The spraying device can, for example, have application elements that can be switched individually or in groups. For example, the spraying device has part-width section control. Preferably, upcoming, in particular planned, changes to the number of active application elements and/or the position of the active application elements in the line system are determined until the area-internal application limit is reached, in particular by evaluating a planned application routine. The control unit preferably calculates the provision delay depending on the determined number of active application elements and/or the position of the active application elements in the line system and/or the imminent changes in the number of active application elements and/or the position of the active application elements in the line system until the area-internal application limit is reached. As the number of active application elements increases, the provision delay is reduced since the time required to exchange the fluid in the line volume is reduced. If the flow rate is taken into account, the number of active application elements does not necessarily have to be taken into account when determining the provision delay.

With regard to application elements arranged in the middle of the boom or with regard to a partial width arranged in the middle of the boom, the shorter line length between the infeed point and the application elements results in a shorter provision delay than with regard to application elements that are located on the outside of the boom or a partial width that is located on the outside of the boom. The number of active application elements and/or the positions of the active application elements in the line system and/or the imminent change in the number of active application elements and/or the position of the active application elements in the line system until the area-internal application limit is reached can be stored in the control unit as application parameters or can be called up by the control unit.

When cornering, the application elements can cover different cornering paths at different cornering speeds. The different cornering paths and/or cornering speeds of the application elements and/or a cornering-indicative signal, in particular a sensor-determined rotation rate, can be taken into account when determining the provision delay.

The direct infeed system can also have several infeed points, wherein each infeed point is assigned to an infeed partial width with several application elements. If only one infeed partial width of several infeed partial widths is active, the fluid exchange is significantly lower than if all infeed partial widths are active. This also significantly increases the provision delay when the active substance concentration changes.

The provision delay can also be calculated as a function of which partial widths are active. The fluid exchange at outer partial widths takes longer than the fluid exchange at inner or centered partial widths.

The current provision delay is 20 s and a higher concentration is to be present at the application elements in 20 s. After 10 s, the number of active application elements and/or the target application rate is doubled. The provision delay is then halved to 10 s or 5 s if both the number of application elements and the target application rate are doubled. If a provision delay of 20 s had been taken into account for the infeed, the infeed would have started too early. With the predictive information about the future process parameters that influence the provision delay, the infeed error can therefore be reduced or prevented. The calculation applies in the same way if the provision delay increases in a few meters and the infeed has to start earlier as a result.

Furthermore, in another embodiment, the area-internal application limit, the adjustment location, the adjustment time, the provision delay, in particular as a delay time or lag distance, are visualized by means of an electronic display device, in particular in connection with a map view. By visualizing these parameters, the machine operator can check the upcoming application routine and, if necessary, intervene if a deviating application is to be implemented due to circumstances that the control unit does not take into account.

Furthermore, in another embodiment, is determined whether an active substance or higher or lower active substance concentrations are to be prioritized. As a function of this prioritization, it is ensured that the prioritized active substance concentration is applied at the area-internal application limit. As a result, it may be necessary, for example, to determine a different provision delay for an increase in the active substance concentration than for a decrease in the active substance concentration. The prioritization of an active substance or a higher or lower active substance concentration can be taken into account when determining the provision delay.

Furthermore, in another embodiment, the spray fluid with the changed active substance concentration reaches the application elements of the spraying device at a time interval due to different line lengths leading to the application elements, wherein the control unit is configured to manipulate a determined provision delay to adjust the overlap between the target application area for the spray fluid with the changed active substance concentration and the actual application area of the spray fluid with the changed active substance concentration. For example, there are different provision delays in relation to the respective application elements. The operator can specify the overlap via an input in order to influence the manipulation of the provision delay.

Furthermore, in another embodiment, the control unit manipulates the provision delay differently when the active substance concentration is increased than when the active substance concentration is reduced. Depending on whether higher or lower active substance concentrations are to be prioritized, the determined provision delay can be shortened or extended. To start the application of the spray fluid to the agricultural area, for example, a condition can be set in which active substance is present at the application elements in the intended concentration. The initially required active substance concentration can be taken from an application map, for example.

For example, the agricultural spraying device can exchange information with a task controller within the scope of the method. The control unit can be part of the task controller. For example, the agricultural spraying device informs the task controller about the volume of fluid to be exchanged in the line system until a spray fluid with a changed active substance concentration is present at the application elements. The task controller can take this information into account in its calculations and transmit fluid exchange volume-specific setting parameters to the agricultural spraying device. For this purpose, information about the intended target quantities and/or intended active substance ratios can be exchanged between the task controller and the agricultural spraying device. Within the scope of a control system and/or regulation, the actual quantities and/or active substance ratios of carrier fluid and/or spray fluid and/or active substances are adjusted to the respective target quantities and/or intended active substance ratios.

The performance can be further improved by a system of the type introductorily mentioned, wherein the control unit is adapted to automatically cause the active substance concentration of the spray fluid to be changed before the application elements reach an area-internal application limit running within an agricultural area, so that the spray fluid with the changed active substance concentration is present at one or more application elements when the area-internal application limit is reached.

In another preferred embodiment, the system is configured to operate the direct infeed system according to a method according to one of the preceding embodiments.

### BRIEF DESCRIPTION OF THE DRAWINGS

In the following, preferred embodiments are explained and described in more detail with reference to the accompanying drawings. It is shown by:

FIG. 1 shows an embodiment of the system according to an embodiment for controlling the application of spray fluid in a schematic view;

FIG. 2 shows the application of spray fluid to an agricultural area in a schematic view;

FIG. 3 shows the application of spray fluid to an agricultural area in a schematic view;

FIG. 4 shows a spray fluid distribution on an agricultural area implemented by the method taking into account an application map specifying an area-specific active substance concentration, in a schematic view;

FIG. 5 shows a spray fluid distribution on an agricultural area implemented by the method taking into account an application map specifying an area-specific active substance concentration, in a schematic view;

FIG. 6 shows a spray fluid distribution on an agricultural area implemented by the method, taking into account an application map specifying an area-specific active substance concentration, in a schematic view;

FIG. 7 shows a spray fluid distribution on an agricultural area implemented by the method, taking into account an application map specifying an area-specific active substance concentration, in a schematic view;

FIG. 8 shows a spray fluid distribution on an agricultural area implemented by the method, taking into account an application map specifying an area-specific active substance and carrier fluid concentration, in a schematic view.

### DETAILED DESCRIPTION

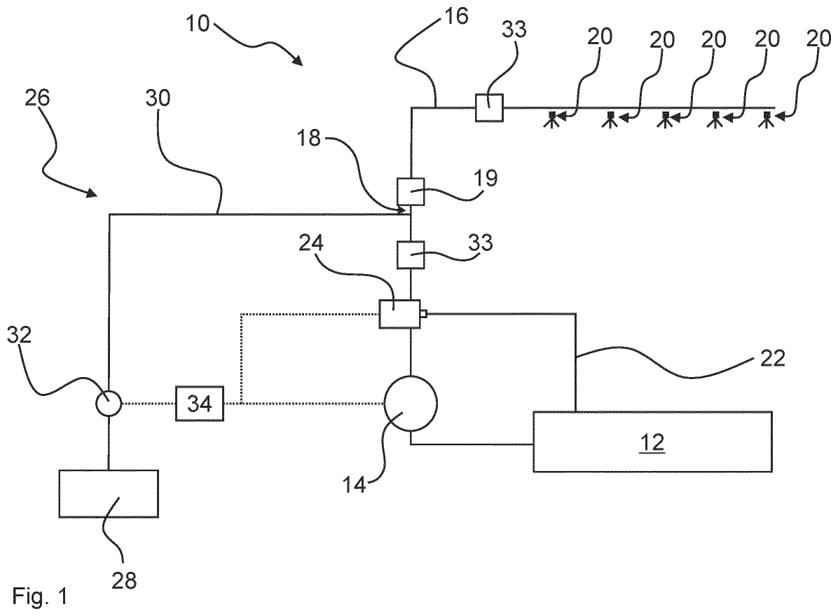

FIG. 1 shows a system 10 for controlling the application of spray fluid by an agricultural spraying device 36. The system 10 comprises a main tank 12, which is part of the agricultural spraying device 36 and in which carrier fluid is stored. The carrier fluid is fed to application elements 20 of the agricultural spraying device 36 by means of a main pump 14 and a line system 16 via an infeed point 18. The application elements 20 are spray nozzles arranged on a boom 38 of the spraying device 36. Several application elements 20 can be combined to form partial widths. In order to interrupt or control the application of the spray fluid, valves can be arranged in or upstream of the application elements 20, via which the flow of the spray fluid through the individual application elements 20 can be interrupted or controlled. The line system 16 further comprises a return line 22, via which carrier fluid pumped by the main pump 14 can be returned to the main tank 12. For this purpose, the line system 16 comprises a return valve 24, via which the carrier fluid can be directed either to the infeed point 18 or back into the main tank 12 via the return line 22.

In addition, the system 10 comprises a direct infeed system 26, by means of which an active substance can be fed into the line system 16 conducting the carrier fluid. The infeed of the active substance takes place at the infeed point 18. The direct infeed system 26 comprises an active substance container 28 for storing the active substance to be dosed. The active substance is conveyed to the infeed point 18 via the feed pump 32 and the infeed line 30. The active substance and carrier fluid are mixed together in a mixing chamber 19 downstream of the infeed point 18.

The main pump 14 and the feed pump 32 are connected to a control unit 34, via which the feed rate of the main pump 14 and the feed pump 32 can be controlled. By controlling the feed rate of the main pump 14 and the feed pump 32, the active substance concentration K1, K2 of the spray fluid can be changed by adjusting the active substance feed rate and by adjusting the volume flow rate of the carrier fluid at the infeed point 18. The control unit 34 can consist of several modules.

Between the infeed point 18 and the application elements 20, which are configured as spray nozzles, there are several meters of hose line. If a new active substance concentration K1, K2 is to be composed, the entire fluid between the infeed point 18 and the application elements 20 must be exchanged. The control unit 34 takes into account the time delay resulting from the line length between the change in the active substance feed rate and the actual discharge of the intended spray fluid at the application elements 20. The control unit 34 automatically causes the active substance concentration K1, K2 of the spray fluid to be changed before the application elements 20 reach an area-internal application limit G, G′, G1-G8 running within an agricultural area N, so that the spray fluid with the changed active substance concentration K1, K2 is present at one or more application elements 20 when the area-internal application limit G, G′, G1-G8 is reached.

Due to the fact that the spray fluid with the modified active substance concentration K1, K2 is present at the one or more application elements 20 when the area-internal application limit G, G′, G1-G8 is reached, the spray fluid with the changed active substance concentration K1, K2 can be applied directly at the area-internal application limit G, G′, G1-G8. The feed pump 32 of the direct infeed system 26 adds the required amount of active substance to the carrier fluid in advance, so that the spray fluid with the intended active substance concentration K1, K2 is discharged from the one or more application elements 20 as soon as the application elements 20 pass over the area-internal application limit G, G′, G1-G8.

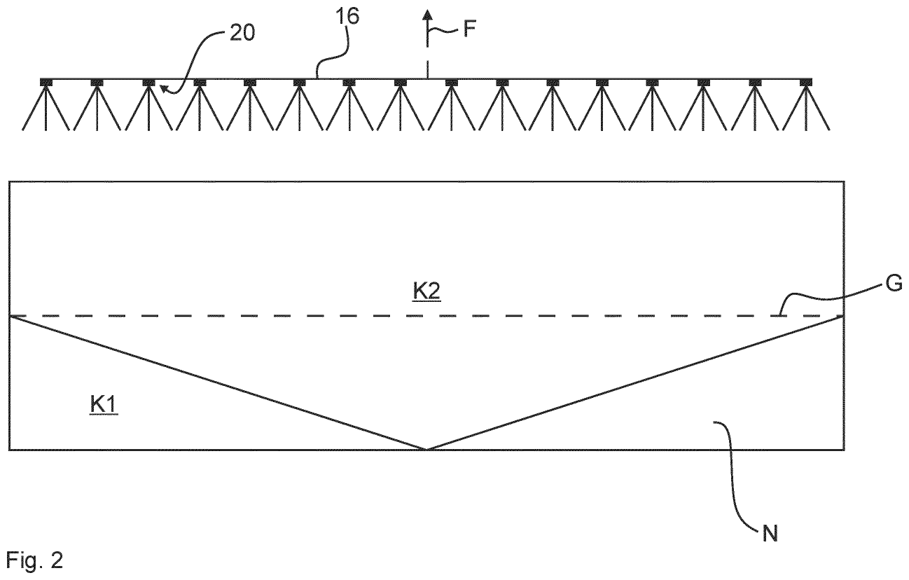

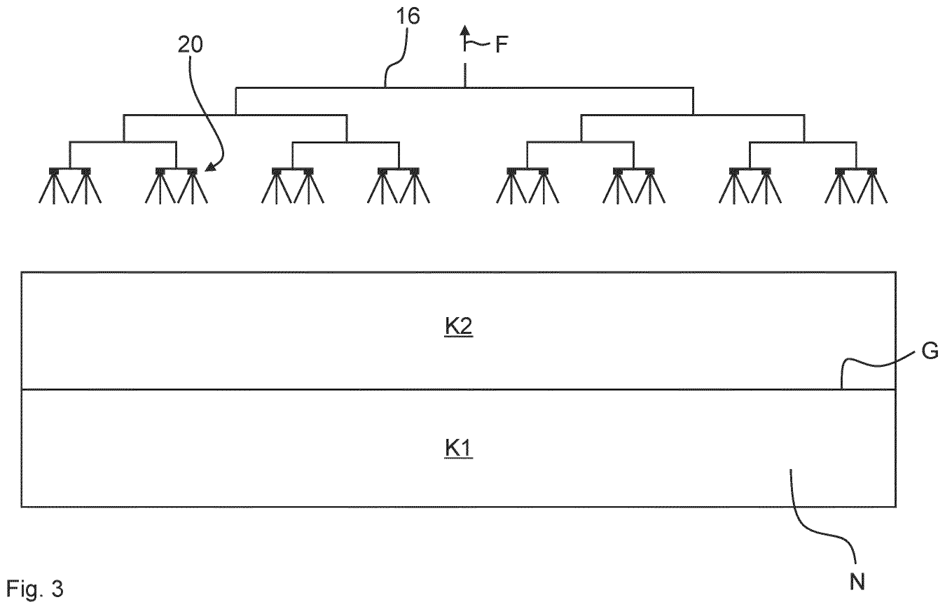

FIGS. 2 and 3 show that the structure of the line system 16 and the integration of the application elements 20 into the line system 16 have a considerable influence on the distribution of the active ingredient on the agricultural area N.

In the case of anticipatory dosing of the active substance by the feed pump 32 of the direct infeed system 26 before the application limit G is reached, a V-shaped transition area results between the area segment in which a spray fluid with the active substance concentration K1 has been applied to the agricultural area N in the case of a constant forward movement in the direction of travel F, and the area segment in which a spray fluid with the active substance concentration K2 has been applied to the agricultural area N, if the line length between the infeed point 18 and the application elements 20 depends on the positioning of the application elements 20. In FIG. 2, the lines to the application elements 20 arranged in the outer area are longer than the lines to the application elements 20 arranged in the center of the boom.

FIG. 3 shows a line system 16 in which the line length between the infeed point 18 and the respective application elements 20 coincides due to a tree structure. With a corresponding line system 16, it is possible to avoid the V-shaped active substance distribution on the agricultural area N, so that a transition area running perpendicular to the direction of travel F is created between the area segment in which the spray fluid has the active substance concentration K1 and the area segment in which the spray fluid has the active substance concentration K2.

There can be various intermediate stages between the configurations in FIGS. 2 and 3. The configuration shown in FIG. 2, for example, is simple and inexpensive, but has an extended transition area. The configuration according to FIG. 3 can avoid this transition area, but a longer line system 16 is required. A preferred intermediate stage can therefore be optimized for a compromise between line length and transition area.

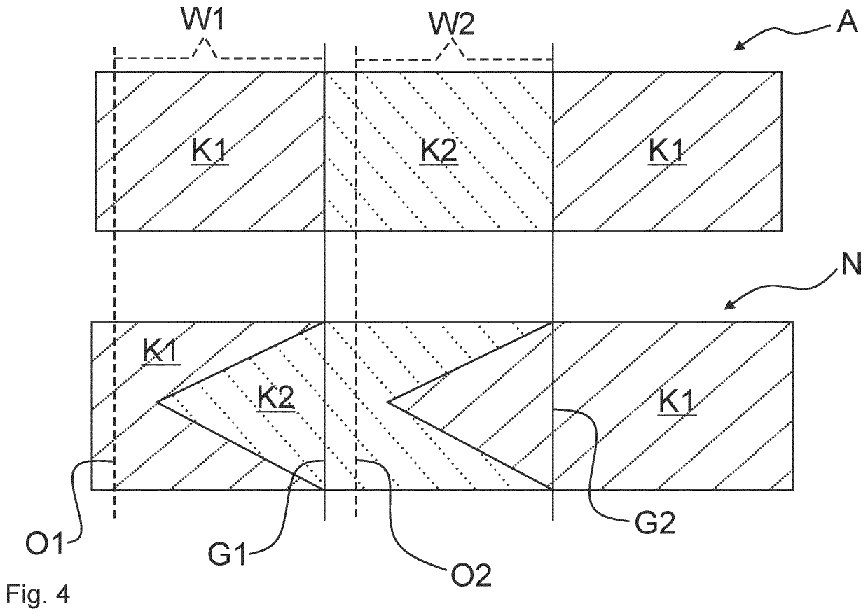

FIG. 4 shows an application map A in the upper area, wherein the control unit 34 initiates an anticipatory change in the active substance concentration K1, K2 of the spray fluid on the basis of the application map A.

The control unit 34 causes the active substance concentration K1, K2 of the spray fluid to be changed already at the adjustment locations O1, O2 on the agricultural area N, wherein the adjustment locations O1, O2 are located before the corresponding area-internal application limits G1, G2. The control unit 34 determines the adjustment locations O1, O2 taking into account a dynamic provision delay of the spray fluid with the changed active substance concentration K1, K2 at the application elements 20.

The provision delay depends on the flow rate of the spray fluid through the line system 16 and corresponds to the flow duration of the spray fluid with the changed active substance concentration K1, K2 from the infeed point 18 to the application elements 20. The provision delays determined by the control unit 34 can, for example, relate to the lag distances W1, W2 between the adjustment locations O1, O2 and the area-internal application limits G1, G2. Alternatively, the provision delays may also relate to the delay times between the adjustment times and the times at which one or more application elements 20 reach the area-internal application limits G1, G2.

Due to the structure of the line system 16, there is a V-shaped transition area between the area segments with the different active substance concentrations K1, K2 even with an anticipatory early change in the infeed quantity of active substance. The control unit 34 controls the feed pump 32 such that the new active substance concentration K1, K2 is present at all application elements 20 when the area-internal application limits G1, G2 are reached.

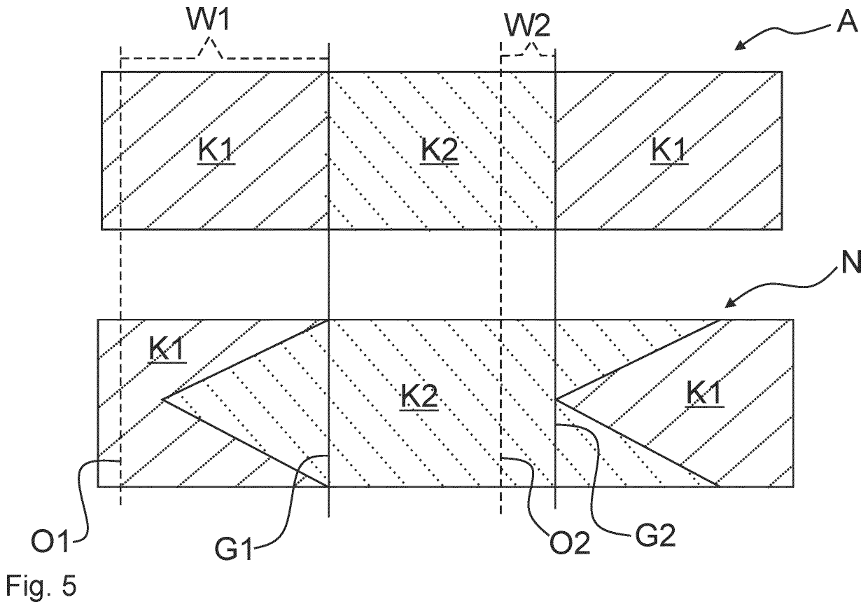

In the application process shown in FIG. 5, the control unit 34 determines the provision delay differently when the active substance concentration K1, K2 is increased than when the active substance concentration K1, K2 is reduced. When the active substance concentration is increased from K1 to K2, the control unit 34 calculates the provision delay so that the active substance concentration K2 is present at all application elements 20 when the application limit G1 is reached. When the active substance concentration is reduced from K2 to K1, the control unit 34 calculates the provision delay so that when the application limit G2 is reached, the active substance concentration K1 is initially only present at one or more central application elements 20, thus at the application elements 20 for which the line length between infeed point 18 and application element 20 is minimal. This results in different lag distances W1, W2. Such a control routine is preferred if the higher active substance concentration K2 is prioritized over the lower active substance concentration K1. Via a control unit 34, a user can specify, for example, whether a higher or lower active substance concentration K1, K2 is to be prioritized, so that the control unit 34 can take into account a shortening or lengthening of the provision delay to implement the intended prioritization.

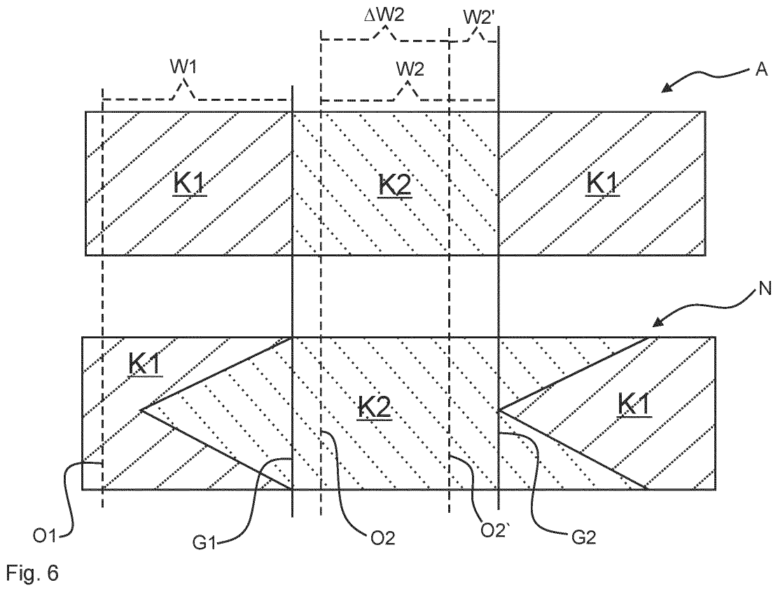

In the application process shown in FIG. 6, the control unit 34 manipulates a provision delay to adjust the overlap between the target application area for the spray fluid with the changed active substance concentration K1, K2 and the actual application area of the spray fluid with the changed active substance concentration K2. By manipulating the provision delay, the adjustment location O2, at which the control unit 34 causes the active substance concentration K1, K2 of the spray fluid to be changed, is shifted by a distance difference ΔW2 to the manipulated adjustment location O2′, resulting in a manipulated lag distance W2′.

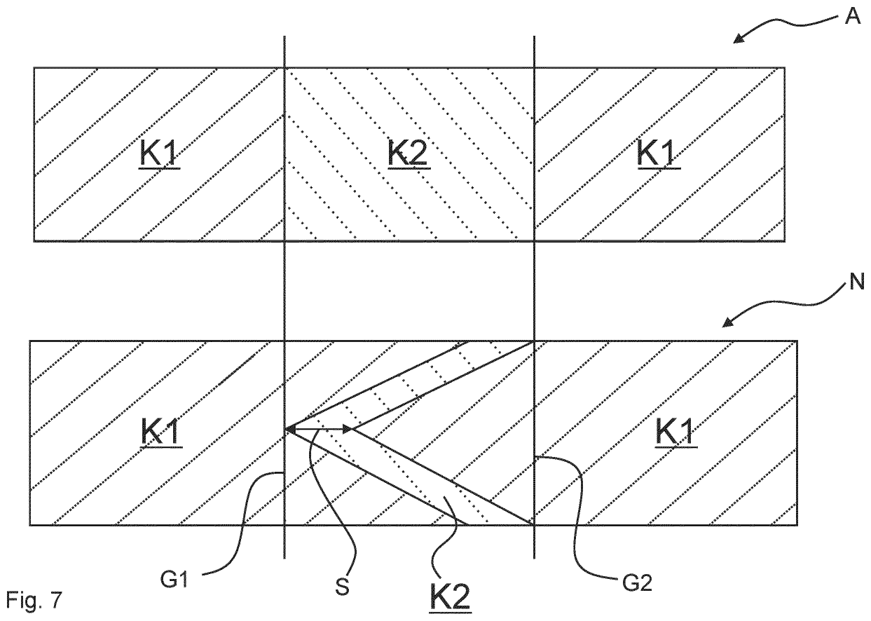

FIG. 7 shows an application process in which the control unit 34 prioritizes the lower active substance concentration K1. When the application limit G1 is reached, the higher active substance concentration K2 is only present at the application elements with the shortest line length to the infeed point 18. At the area-internal application limit G2, the active substance concentration K1 is present at all application elements 20.

The control unit 34 can calculate the lag distance W1, W2 in the application situations described above, for example, taking into account a fluid exchange volume, which relates to the line volume between the infeed point 18 and the application elements 20. Furthermore, the control unit 34 can take into account an area-related application rate of carrier fluid or spray fluid and the working width of the spraying device 36 until the area-internal application limits G1, G2 are reached.

It can happen that a non-prioritized active substance concentration K1, K2 is only applied for a short distance S or a short period of time. If this distance S or time period falls below an adjustable limit value, it can be determined not to change the active substance concentration. The limit value can have similar dependencies as the provision delay. It can also depend on the active substances and/or the carrier fluid.

In the examples shown, the flow rate, the flow volume and/or the flow velocity, of the carrier fluid and/or spray fluid through the line system 16 can further be measured by means of one or more flow measuring devices 33. The control unit 34 can then calculate the provision delay as a function of the measured flow rate, since the time period within which the fluid volume is exchanged between the infeed point 18 and the application elements 20 depends on the flow rate of the carrier fluid and/or the spray fluid through the line system 16.

Furthermore, during the application of the spray fluid to the agricultural area N, the current driving speed can be determined and imminent changes in the driving speed until the area-internal application limit is reached can be determined, for example by evaluating a planned application routine. The control unit 34 can then calculate the provision delays as a function of the determined current driving speed and the determined imminent changes in driving speed until the area-internal application limit G1, G2 is reached.

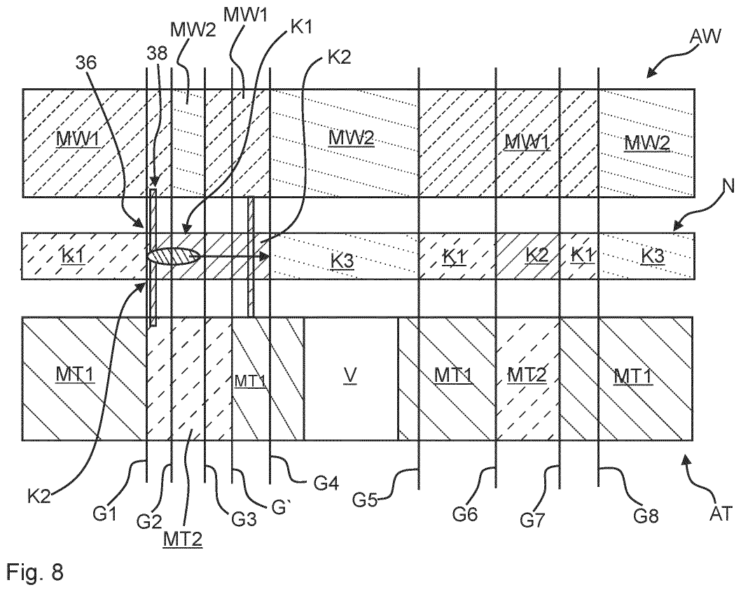

FIG. 8 shows an application process in which the control unit 34 takes into account application maps AW, AT, wherein the application map AW specifies area-specific active substance quantities and the application map AT specifies area-specific carrier fluid quantities. The spraying device 36, which has a boom 38, has a direct infeed system 26, which changes the ratio of the area-specific application quantity of active substance and the area-specific application quantity of carrier fluid in order to change the active substance concentration K1-K3.

A spray fluid with the active substance concentration K1 is to be applied up to the application limit G1. This active substance concentration K1 can be generated by dosing the target active substance quantity MW1 into a target carrier fluid quantity MT1. Between the application limits G1 and G2, a spray fluid with the active substance concentration K2 should be applied. This active substance concentration K2 can be generated by dosing the target active substance quantity MW1 into the target carrier fluid quantity MT2. Between the application limits G2 and G3, a spray fluid with the active substance concentration K1 should be applied. This active substance concentration K1 can be generated by dosing the target active substance quantity MW2 into the target carrier fluid quantity MT2. Between the application limits G3 and G4, a spray fluid with the active substance concentration K2 should be applied. Up to the application limit G′, the spray fluid with the active substance concentration K2 is generated by dosing the active substance quantity MW1 into the target carrier fluid quantity MT2. Between the application limits G′ and G4, the spray fluid with the active substance concentration K2 is generated by dosing the target active substance quantity MW1 into the target carrier fluid quantity MT1.

Between the application limits G4 and G5, a spray fluid with the active substance concentration K3 is to be applied. The active substance concentration K3 is generated by dosing the target active substance quantity MW2 into the target carrier fluid quantity MT1. It is also taken into account that the spraying device 36 passes through the headland V between the area-internal application limits G4 and G5.

Between the application limits G5 and G6, a spray fluid with the active substance concentration K1 is to be applied. This active substance concentration K1 is generated by dosing a target active substance quantity MW1 into a target carrier fluid quantity MT1.

Early before the application limits G6, G7 and G8, the control unit 34 causes further changes in the active substance concentration in the spray fluid, wherein the active substance concentration is changed again by setting a target active substance quantity MW1, MW2 and/or by setting a target carrier fluid quantity MT1, MT2.

### LIST OF REFERENCE SIGNS

10 system
12 main tank
14 main pump
16 line system
18 infeed point
19 mixing chamber
20 application elements
22 return line
24 return valve
26 direct infeed system
28 active substance container
30 infeed line
32 feed pump
33 flow measuring device
34 control unit
36 spraying device
38 boom
A, AT, AW application maps
F direction of travel
G, G′, G1-G8 application limits
K1, K2, K3 active substance concentrations
MW1, MW2 target active substance quantities
MT1, MT2 target carrier fluid quantities
N agricultural area
O1, O2, O2′ adjustment locations
V headland
W1, W2, W2′ lag distances
ΔW2 distance difference
S distance

1. A method for operating an agricultural spraying device having a direct infeed system, comprising:
feeding an active substance into a line system of the agricultural spraying device, said line system being connected to application elements and conducting a carrier fluid, using the direct infeed system in order to generate a spray fluid containing the active substance and the carrier fluid, wherein the feeding of the active substance takes place at an infeed point of the line system; and
changing a concentration of the active substance of the spray fluid by adjusting infeed of the active substance infeed and/or by adjusting a volume flow of the carrier fluid at the infeed point;
wherein a control unit automatically causes the active substance concentration of the spray fluid to be changed before the application elements reach an area-internal application limit within an agricultural area, so that the spray fluid with the changed active substance concentration is present at one or more application elements when the area-internal application limit is reached.

2. The method according to claim 1,
wherein the control unit causes the active substance concentration of the spray fluid to be changed at an adjustment location on the agricultural area and/or at an adjustment time during an application process and determines the adjustment location and/or the adjustment time, taking into account a dynamic provision delay of the spray fluid with the changed active substance concentration at the one or more application elements.

3. The method according to claim 2,
wherein the dynamic provision delay determined by the control unit
relates to a delay time between the adjustment time and a time at which the one or more application elements reach the area-internal application limit; or
relates to a lag distance between the adjustment location and the area-internal application limit.

4. The method according to claim 3,
wherein the control unit calculates the lag distance taking into account a fluid exchange volume, an area-related application rate of carrier fluid or spray fluid and/or a working width of the spraying device until the area-internal application limit is reached.

5. The method according to claim 3,
wherein the control unit calculates the lag distance taking into account a travel path and application interruptions occurring along the travel path, until the area-internal application limit is reached.

6. The method according to claim 2, further comprising:
measuring a flow rate, in particular a volume flow rate and/or a flow velocity, of the carrier fluid and/or the spray fluid through the line system by means of one or more flow measuring devices,
wherein the control unit calculates the dynamic provision delay as a function of the measured flow rate.

7. The method according to claim 2, further comprising:
determining imminent, in particular planned, changes in a flow rate, in particular the volume flow rate and/or the flow velocity, of the carrier fluid and/or the spray fluid through the line system until the area-internal application limit is reached, in particular by evaluating a planned application routine,
wherein the control unit calculates the dynamic provision delay as a function of the determined imminent changes in the flow rate of the carrier fluid and/or the spray fluid through the line system until the area-internal application limit is reached.

8. The method according to claim 2, further comprising:
determining a current driving speed;
determining imminent, in particular planned, changes in the driving speed until the area-internal application limit is reached, in particular by evaluating a planned application routine,
wherein the control unit calculates the dynamic provision delay as a function of the determined current driving speed and/or the determined imminent changes in driving speed until the area-internal application limit is reached.

9. The method according to claim 2, further comprising:
determining a current target application rate of carrier fluid and/or spray fluid;
determining imminent, in particular planned, changes in the target application rate of carrier fluid and/or spray fluid until the area-internal application limit is reached, in particular by evaluating a planned application routine,
wherein the control unit calculates the dynamic provision delay as a function of the determined current target application quantity of carrier fluid and/or spray fluid and/or the determined imminent changes in the target application quantity of carrier fluid and/or spray fluid.

10. The method according to claim 2,
determining a number of active application elements and/or the position of the active application elements in the line system,
determining imminent, in particular planned, changes with regard to the number of active application elements and/or the position of the active application elements in the line system until the area-internal application limit is reached, in particular by evaluating a planned application routine,
wherein the control unit calculates the dynamic provision delay as a function of the determined number of active application elements and/or the positions of the active application elements in the line system and/or the imminent changes with regard to the number of active application elements and/or the positions of the active application elements in the line system until the area-internal application limit is reached.

11. The method according to claim 2,
wherein the area-internal application limit, the adjustment location, the adjustment time, the dynamic provision delay, in particular as a delay time or lag distance, are visualized by means of an electronic display device, in particular in connection with a map view.

12. The method according to claim 2,
wherein the spray fluid with the changed active substance concentration reaches the application elements of the spraying device with a time delay due to line lengths leading to the application elements deviating from one another, wherein the control unit manipulates a determined provision delay to adjust the overlap between the target application area for the spray fluid with the changed active substance concentration and the actual application area of the spray fluid with the changed active substance concentration.

13. The method according to claim 12,
wherein the control unit manipulates the provision delay differently when the active substance concentration is increased than when the active substance concentration is reduced.

14. A system for controlling the application of spray fluid by an agricultural spraying device, comprising:
a direct infeed system, by which an active substance can be fed into a line system of the agricultural spraying device, said line system being connected to application elements and conducting a carrier fluid, in order to generate a spray fluid comprising the active substance and the carrier fluid, wherein the direct infeed system is adapted to feed in the active substance at an infeed point of the line system; and
a control unit which is adapted to cause a change in an active substance concentration of the spray fluid by adjusting the active substance feed and/or by adjusting a volume flow of the carrier fluid at the infeed point;
wherein the control unit is adapted to automatically cause the active substance concentration of the spray fluid to be changed before the application elements reach an area-internal application limit within an agricultural area, so that the spray fluid with the changed active substance concentration is present at one or more application elements when the area-internal application limit is reached.

15. The system (according to claim 14,
wherein the system is adapted to operate the direct infeed system according to one of claim 1.
